(19) United States
(12) Patent Application Publication
(10) Pub. No.: US 2010/0289629 A1
(43) Pub. Date: Nov. 18, 2010

(54) Load Control Device with Two-Way Communication Capabilities

(75) Inventors: Kevin Charles Allmaras, Carrington, ND (US); Craig Harper, Maple Grove, MN (US)

Correspondence Address: King & Spalding LLP, 1100 Louisiana St., Suite 4000, ATTN.: IP Docketing, Houston, TX, 77002-5213, US

(73) Assignee: COOPER TECHNOLOGIES COMPANY, Houston, TX (US)

(21) Appl. No.: 12/846,424

(22) Filed: Jul. 29, 2010

Related U.S. Application Data
(63) Continuation-in-part of application No. 12/259,859, filed on Oct. 28, 2008.

(51) Int. Cl. G05B 11/01

(52) U.S. Cl. 340/310.11

(57) ABSTRACT

A load control device having two-way communication capabilities. The load control device can include a conventional load control receiver that receives information, such as load control commands or requests. The load control receiver can include a receiver operable to receive power line carrier signals via a power distribution line. The load control device can further include a power line carrier signal transmitter that couples a power line carrier signal onto the distribution line. The power line carrier signal transmitter can communicate information associated with the load control device and information associated with one or more electrical devices that are controlled by the load control device to a remote device. The information may be transmitted from the load control device to the remote device in response to a request received by the load control device or on a periodic basis.

### CROSS REFERENCE TO RELATED APPLICATIONS

This non-provisional application is a continuation-in-part of and claims priority under 35 U.S.C. §120 to U.S. patent application Ser. No. 12/259,859, titled, “Method and Apparatus for Stimulating Power Line Carrier Injection with Reactive Oscillation,” filed Oct. 28, 2008, the entire contents of which are hereby fully incorporated herein by reference.

### TECHNICAL FIELD

The present invention relates generally to load control devices, and more particularly to load control devices having two-way communication capabilities.

### BACKGROUND

Load control is a process where utility companies can regulate the supply (load) of electricity based on real-time data received during peak usage periods. This load control process is performed to conserve electricity and ensure that customer demand does not exceed available supply. Utilities may identify certain applications or devices that can be deferred to run at a different time. These applications may vary by region and can include residential heating, ventilating, and air conditioning (HVAC) systems, electric water heaters, swimming pool pumps and heaters, water wells, crop irrigation pumps, and other electrical devices. For example, a utility may defer residential pool pumps until the evening hours when peak demand has subsided.

If a utility (or other entity) is interested in controlling a load generated by a device, the utility can outfit the device with a load control receiver. The load control receiver can control the load of the device directly or indirectly via a low voltage circuit, such as a thermostat or contactor. Some load control receivers execute a program that limits the duty cycle of the device under control. Conventional load control receivers typically include a receiver for receiving load control commands from the utility. The utility can selectively control the load by sending a load control command to the load control receiver instructing the receiver to either reduce load or to completely shut down the device, typically for a certain amount of time.

Some conventional load control receivers receive commands from a utility via power line carrier signals. The power line carrier signals are sent from the utility to an end user via power distribution lines. Typically, a power line carrier signal is generated by supplying a sinusoidal signal at the input of an amplifier. The signal is amplified and then injected onto the power line by injecting it into the secondary winding of a power transformer that is connected to the power line or injecting it directly onto the power line through high voltage capacitors. In the case of the transformer type injection, the signal that is injected into the secondary winding of the transformer induces a signal on the primary winding of the transformer which is connected to the power line. Digital data is communicated by modulating the phase of the carrier signal that is induced onto the power line. For conventional power line carrier infrastructure, large capacitors may be used to couple the carrier signal onto the distribution lines. These large capacitors make them unsuitable for transmitting signals from a remote device, such as a load control receiver.

Some conventional load control receivers provide information gathering capabilities. For example, conventional load control receivers can log data related to how long an attached device has been actively powered. However, obtaining this information from a conventional load control receiver requires a technician (or other person) to travel to the load control receiver and access the information via a local communication mechanism, such as infrared communication between the load control receiver and another device or a serial cable connected between the load control receiver and a mobile computer. Traveling to each load control receiver to access information is extremely expensive and labor intensive for a utility.

Accordingly, a need exists within the art for a load control device capable of transmitting information to a utility or to a remote device. Another need exists for a load control device capable of transmitting information to a remote device in real time or near real time, for example in response to an event.

### SUMMARY

The present invention provides a load control device having two-way communication capabilities. The load control device can include a conventional load control receiver that receives information, such as load control commands or requests. The load control receiver can include a receiver operable to receive power line carrier signals via a power distribution line. The load control device can further include a power line carrier signal transmitter that couples a power line carrier signal onto the distribution line. The power line carrier signal transmitter can communicate information associated with the load control device and information associated with one or more electrical devices that are controlled by the load control device to a remote device. The information may be transmitted from the load control device to the remote device in response to a request received by the load control device or on a periodic basis.

The power line carrier transmitter can stimulate power line carrier signals without a large power supply or large capacitor to couple the carrier signal onto a power distribution line. The power line carrier transmitter utilizes short pulses of current to excite a tank circuit and therefore cause the tank circuit to oscillate at the frequency of excitation, which can be near the natural resonant frequency of the tank circuit. This process allows the carrier signal to be coupled onto the distribution line through the power transformer, rather than a large power supply or large capacitor. The power line carrier signals coupled to the distribution line can include information associated with the load control device and electrical devices controlled by the load control device.

An aspect of the present invention provides a load control device. The load control device can include a load controller operable to control electrical power to a device. The load control device can also include a power line carrier transmitter, logically coupled to the load controller, that transmits information to a remote device by coupling a power line carrier signal to a power distribution line, the power line carrier signal comprising the information.

Another aspect of the present invention provides a method for transmitting information from a load control device to a remote device via a power distribution line. The method can include a power line carrier transmitter residing at the load control device coupling a power line carrier signal to the distribution line. The phase of the power line carrier signal can be adjusted based on the information for transmission.

Yet another aspect of the present invention provides a load control device. The load control device can include a load controller operable to control power supplied to an electrical device from a power distribution system in response to a command. The load control device can also include a power line carrier receiver logically coupled to the load controller and operable to receive a first power line carrier signal transmitted along a power line of the power distribution system. The first power line carrier signal can include the command. The load control device can also include a power line carrier transmitter logically coupled to the load controller and operable to transmit information to the remote device by causing a second power line carrier signal to propagate along the power line to the remote device. The second power line carrier signal can include the information.

These and other aspects, objects, features, and embodiments of the present invention will become apparent to those having ordinary skill in the art upon consideration of the following detailed description of illustrative embodiments exemplifying the best mode for carrying out the invention as presently perceived.

### BRIEF DESCRIPTION OF THE DRAWINGS

FIG. 1 is a functional block diagram illustrating a method for stimulating power line carrier injection with reactive oscillation, in accordance with certain exemplary embodiments of the present invention.

FIG. 2 is a schematic illustration of a circuit for stimulating power line carrier injection with reactive oscillation, in accordance with certain exemplary embodiments of the present invention.

FIG. 3 is a functional block diagram of an operating environment for a load control device, in accordance with certain exemplary embodiments of the present invention.

FIG. 4 is flow chart depicting a method for transmitting information from the load control device of FIG. 3, in accordance with certain exemplary embodiments of the present invention.

FIGS. 5A and 5B, collectively FIG. 5, is a schematic illustration of a circuit for stimulating power line carrier injection with reactive oscillation, in accordance with certain exemplary embodiments of the present invention.

The drawings illustrate only exemplary embodiments of the invention and are therefore not to be considered limiting of its scope, as the invention may admit to other equally effective embodiments. The elements and features shown in the drawings are not necessarily to scale, emphasis instead being placed upon clearly illustrating the principles of exemplary embodiments of the present invention. Additionally, certain dimensions may be exaggerated to help visually convey such principles.

### DETAILED DESCRIPTION OF EXEMPLARY EMBODIMENTS

The present invention provides a load control device having two-way communication capabilities. The load control device can include a conventional load control receiver that receives information, such as load control commands or requests. The load control receiver can include a receiver operable to receive power line carrier signals via a power distribution line. The load control device can further include a power line carrier signal transmitter that couples a power line carrier signal onto the distribution line. The power line carrier signal transmitter can communicate information associated with the load control device and information associated with one or more electrical devices that are controlled by the load control device to a remote device. The information may be transmitted from the load control device to the remote device in response to a request received by the load control device or on a periodic basis.

Turning now to the drawings, in which like numerals indicate like (but not necessarily identical) elements throughout the figures, exemplary embodiments of the invention are described in detail.

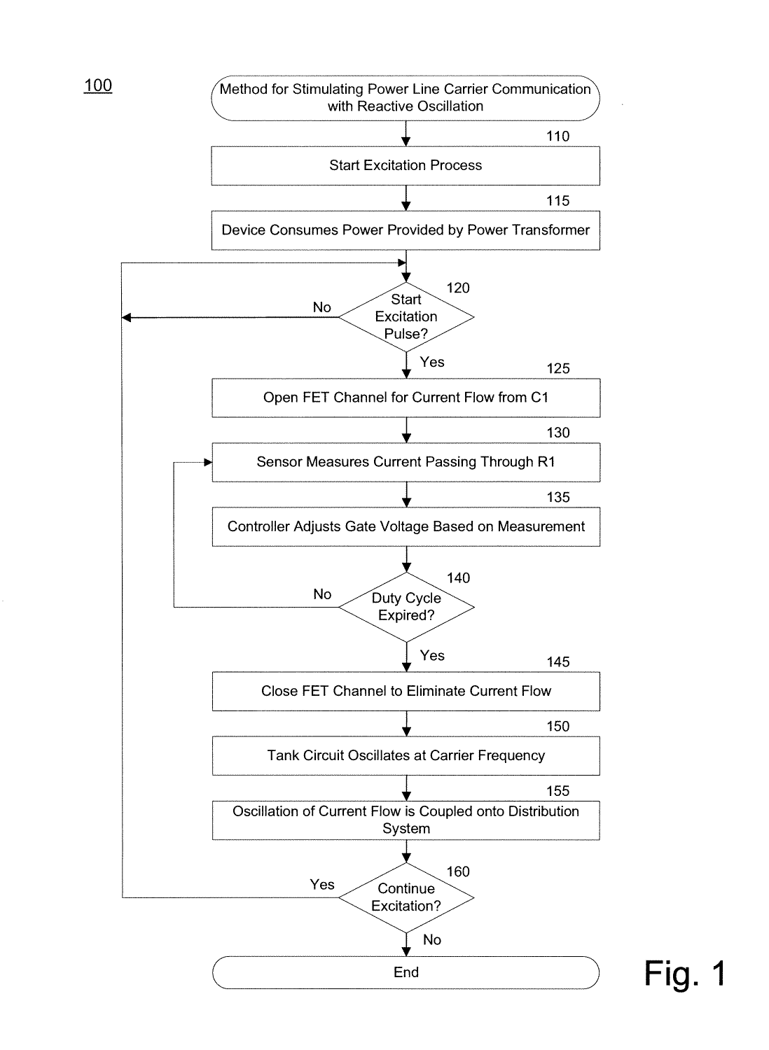

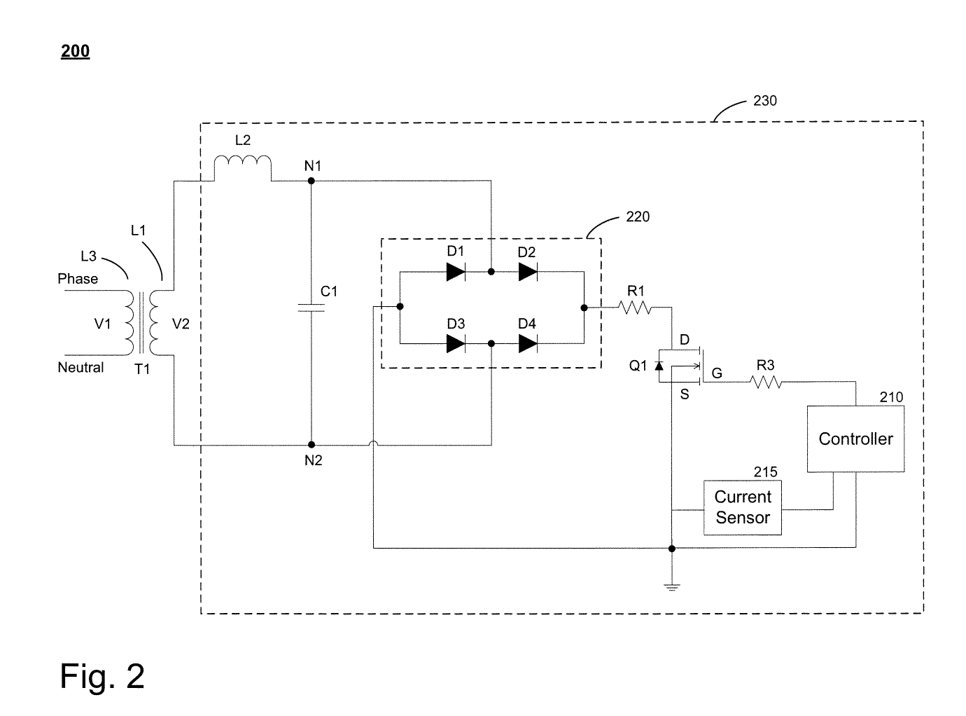

FIG. 1 illustrates a method 100 for stimulating power line carrier injection with reactive oscillation according to an exemplary embodiment of the present invention. FIG. 1 will be described with reference to FIG. 2, which illustrates a circuit 200 for stimulating power line carrier injection with reactive oscillation according to an exemplary embodiment of the present invention.

Step 110 begins the excitation process.

In step 115, a power transformer T1 connected to a distribution system (not shown) serves to provide power to a power line carrier stimulating device 230 and to couple a carrier signal to the distribution system. The power transformer T1 has a primary winding L3 and a secondary winding L1. The primary winding L3 of the power transformer T1 is connected across a single phase of the power line system and the neutral line of the power line system such that an AC voltage is developed across the primary winding L3. Although this exemplary embodiment is described with reference to a single phase of the power line system, poly-phase configurations also are possible using the method described herein.

In a typical application, the power transformer T1 steps the primary voltage V1 on the primary winding L3 down to a lower voltage V2 on the secondary winding L1, or alternatively, the power transformer T1 steps the secondary voltage V2 on the secondary winding L1 up to the voltage V1 on the primary winding L3. For example, the primary voltage V1 may be greater than 1 Kilovolt (KV) and the secondary voltage V2 may be 240 Volts (V).

In step 120, with power provided to the power line carrier stimulating device 230, the device may begin generating excitation pulses.

To inject power line carrier signals onto the distribution system, a tank circuit, is forced to oscillate. The tank circuit comprises the secondary winding L1, an inductor L2, and a capacitor C1. One method of exciting the tank circuit and therefore forcing the tank circuit to oscillate is to sink short pulses of current between one node of the capacitor C1 and the other node of the capacitor C1. The capacitor nodes are represented in FIG. 2 by nodes N1 and N2. If the resonant frequency of the tank circuit is relatively close (within a few kHz) to the frequency of the excitation, the tank circuit will oscillate at the frequency of the excitation pulses. Also, changing the phase of the excitation pulses will cause the same phase change in the oscillations of the tank circuit. This process allows many types of Phase Shift Keying to be possible.

An excitation circuit is utilized to sink short pulses of current between nodes N1 and node N2. In this exemplary embodiment, the excitation circuit includes a FET Q1, a controller 210, two resistors R1 and R3, a full wave rectifier 220, and a current sensor 215 configured as depicted in FIG. 2. Alternative exemplary embodiments may include multiple FETs and other components to refine the power line carrier signal.

In step 125, the channel between the source S and drain D of the FET Q1 is opened to sink pulses of current between node N1 and node N2. This task is accomplished by applying a suitable voltage to the gate G of the FET Q1 to open the channel. The level of voltage required depends upon the FET chosen and the other components included in the circuit. In one exemplary embodiment, the voltage is supplied by a microcontroller included in the controller 210. The controller determines the correct voltage to apply to the gate G of the FET Q1 based on the current sensor feedback. In an exemplary embodiment, the microcontroller can apply voltage to and remove voltage from the gate G of the FET repeatedly at a specified frequency, similar to a square wave.

After the channel between the source S and the drain D of the FET Q1 is opened, the electrical charge stored in the capacitor C1 will discharge through the excitation circuit. As discussed previously, the exemplary excitation circuit comprises the Field Effect Transistor (FET) Q1, the controller 210, two resistors R1 and R3, the full wave rectifier 220, and the current sensor 215 configured as depicted in FIG. 2. The rectifier circuit 220 is connected between nodes N1 and N2 to allow current to flow through the FET Q1 regardless of the polarity of the power line voltage. If the voltage at N1 is greater than the voltage at node N2, current will flow from the node of the capacitor C1 connected to node N1 through diode D2, resistor R1, the drain D of FET Q1, the source S of FET Q1, and finally through diode D3 to reach node N2. If the voltage at N2 is greater than the voltage at node N1, current will flow from the node of the capacitor C1 connected to node N2 through diode D4, resistor R1, the drain D of FET Q1, the source S of FET Q1, and finally through diode D1 to reach node N1.

In an exemplary embodiment, the channel is held open for less than 50% of the period of the desired power line carrier frequency. The amplitude of the output signal can vary with a change in the pulse width, or duty cycle. For a duty cycle of up to about 50% of the period of the carrier frequency, the amplitude increases with an increase in duty cycle. The amplitude of the output signal tends to decrease with an increase of duty cycle above approximately 50% of the carrier frequency.

In the exemplary embodiment illustrated in FIG. 2, the resistor R1 can be included in the circuit between the rectifier 220 and the drain D of the FET Q1 to dissipate some of the power that is flowing through the excitation circuit. If a higher resistance of R1 is chosen, the resistor R1 will dissipate more power and decrease the power requirements of the FET Q1. A lower resistance of R1 allows for greater output power but would require a higher power requirement of the FET Q1.

In step 130, a current sensor 215 measures the current flowing through the source S and drain D of the FET Q1. In one exemplary embodiment, the current sensor 215 includes a low resistance resistor (for example, approximately 50 mΩ) connected between the source S of the FET Q1 and ground. Then, the voltage across the resistor can be amplified and compared to a reference voltage in the controller 210 to determine if the amount of current flowing through the source S and drain D of the FET Q1 is at a desired level.

In step 135, the controller 210 adjusts the level of current flowing through the source S and drain D of the FET Q1 based on the current measurement obtained in step 130. In an exemplary embodiment, the controller 210 includes a FET control circuit (not shown) that adjusts the current flowing through the FET Q1 by adjusting the voltage at the gate G of the FET Q1. The level of voltage at the gate G of the FET Q1 can control the size of the channel between the source S and drain D of the FET Q1, thus allowing more or less current to flow through the channel. A typical FET control circuit includes an operational amplifier, resistors to set the gain of the operational amplifier, and one or more capacitors to filter the output signal.

The use of a FET control circuit and the current sensor 215 allows the controller 210 to maintain a constant current flow through the source S and drain D of the FET Q1. This method prevents damage to the device by reducing current through Q1 and also serves to provide more consistent carrier output. Alternatively, a voltage divider network can be employed at the gate G of the FET Q1 to maintain a consistent voltage level at the gate G of the FET Q1. This method may not provide a consistent current flow through the source S and drain D of the FET Q1 but will still excite the tank circuit.

In step 140, if the duty cycle has not expired, the method returns to step 130 to measure the current flowing through the FET Q1. If the duty cycle has expired, the method proceeds to step 145.

In step 145, the channel between the source and drain of FET Q1 is closed by removing or reducing the voltage at the gate G of the FET Q1.

In step 150, the excitation pulse generated in step 125 causes the tank circuit to oscillate at the frequency of the excitation pulses. The tank circuit includes the secondary winding L1 of the power transformer T1, the inductor L2, and the capacitor C1. As discussed above, the resonant frequency of the tank circuit can be close to the frequency of the carrier signal. The resonant frequency (f) for the tank circuit in FIG. 2 is calculated using formula [1] below, where L is the combined inductance of L1 and L2 in Henries and C is the capacitance of C1 in Farads.

$$f = \frac{1}{2 π \sqrt{LC}} \qquad [ 1 ]$$

The capacitor C1 and the inductor L2 values are chosen to give the resulting tank circuit a resonate frequency that is close to the power line carrier frequency. In an exemplary embodiment, the capacitor C1 and the inductor L2 can be onboard and/or within the enclosure of the power line carrier generation device that contains the excitation circuit. In certain exemplary embodiments, more than one inductor and more than one capacitor may be used in the tank circuit. Other components can be utilized in the tank circuit as well.

When the voltage across the capacitor C1 differs from the voltage across the secondary winding of the transformer T1 (usually due to the excitation pulses), the capacitor C1 begins to recharge by sinking current out of the transformer T1 through the inductor L2. When the voltage across the capacitor C1 reaches the voltage of the secondary winding of the transformer T1, the inductance in the secondary winding of the transformer T2 and the inductor L2 force the capacitor C1 to overcharge to a voltage greater than the voltage across the secondary winding of the transformer T2. This process is responsible for the oscillatory behavior of the device.

In step 155, the oscillation of current flows through the secondary winding L1 of the power transformer T1 and couples the carrier signal onto the primary side of the power transformer and thus onto the distribution system.

In step 160, until it is desired to stop injecting power line carrier signals onto the power line system, the method 100 returns to step 120 and continues sinking pulses of current between one node of capacitor C1 and the other node of capacitor C1 to oscillate the tank circuit and to induce power line carrier signals onto the distribution system.

Although the functional block diagram 100 illustrates steps 125-145 occurring after step 115 and before steps 150 and 155, steps 125-145, step 115, and steps 150 and 155 are typically executing in parallel after steps 125-145 have executed for the first time. Accordingly, these steps may be performed simultaneously or in an alternative order.

Without any additional pulses of current, the tank circuit would oscillate at the resonant frequency of the tank circuit until the overall resistance of the tank circuit causes the oscillation of current to decay. When pulses of current are sunk at or near the resonant frequency of the tank circuit, each pulse builds on the previous pulses to maintain the oscillation of current. For example, the second pulse of current builds on the second oscillation caused by the first pulse of current.

Phase shift keying can be accomplished by adjusting the phase of the excitation pulses. In an exemplary application, the frequency of the power line carrier, and therefore the frequency that the excitation pulses should be applied is 12.5 kHz. The period of a 12.5 kHz signal is 80 microseconds (μs). A 180° phase shift can be accomplished by either shortening the period between one pulse and the next pulse from 80 μs to 40 μs or by lengthening the period between one pulse and the next pulse from 80 μs to 120 μs.

Although the exemplary power line carrier stimulating device 230 is illustrated having a single FET Q1, the power line carrier stimulating device 230 can include any number of FETs. For example, one or more additional FETs can be arranged in parallel with the FET Q1. These additional FETs can be controlled in the same or a substantially similar manner as the FET Q1. The use of multiple FETs in parallel can enable the circuit 200 to sink more current than that of a circuit employing a single FET only.

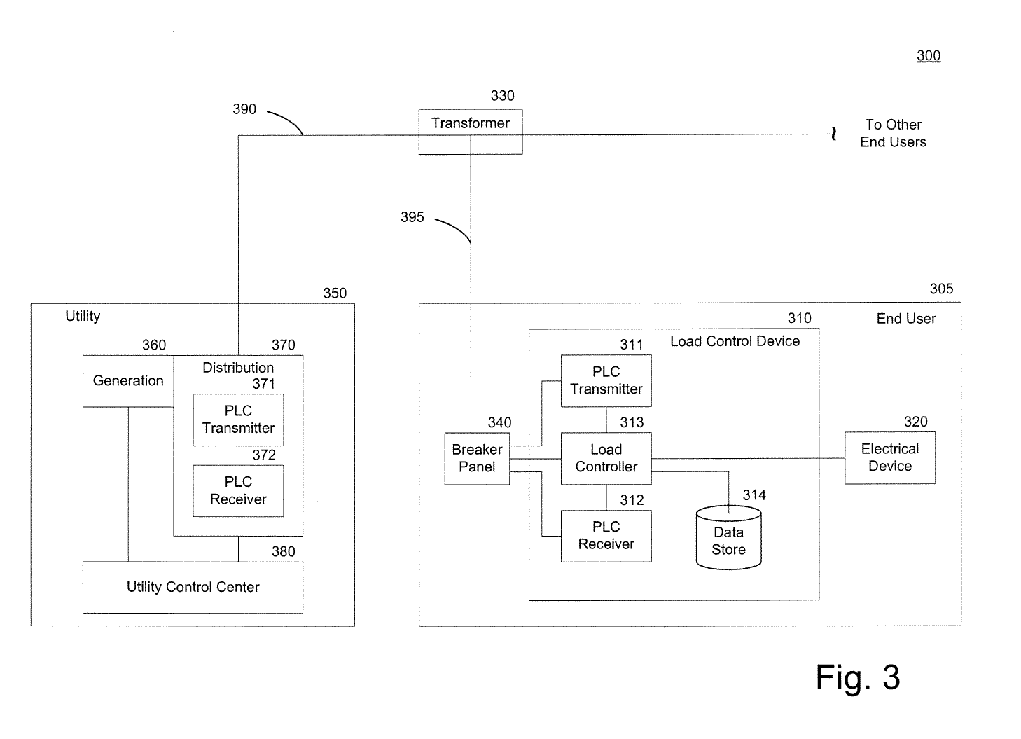

FIG. 3 is a functional block diagram of an operating environment 300 for a load control device 310, in accordance with certain exemplary embodiments of the present invention. Referring to FIG. 3, the operating environment 300 includes a utility 350 that provides electricity to one or more end users, such as end user 305. The exemplary utility 350 includes a utility control center 380 in communication with a power generation system 360 and a power distribution system 370. The generation system 360 includes one or more power generation facilities, such as nuclear plants, fossil fuel burning plants, hydro-electric plants, and solar power facilities. The power distribution system 370 includes transformer-equipped routing stations and substations electrically coupling the generation system 360 to the end user 305 via power distribution lines 390.

The end user 305 can be a residential, business, or industrial user of electricity having one or more electrically powered devices, such as electrical device 320. The electrical device 320 can include, but is not limited to, an air conditioning unit, a furnace, an appliance, a lighting system an electrical water heater, a swimming pool pump or heater, a water well, or a crop irrigation pump. The utility 350 provides electricity to the end user 305 through the distribution lines 390 to power the user's electrically powered devices, including electrical device 320. The electricity from the distribution lines 390 are provided to a breaker panel 340 of the user 305 via a transformer 330 and a drop 395 that includes electrical conductors. The breaker panel 340 includes a series of breakers that divides the electricity between various electrical circuits of the user 305. One such circuit routes electricity to the electrical device 320 by way of the load control device 320.

The exemplary load control device 310 includes a load controller 313 operable to selectively control operation of the electrical device 320 to comply with certain power use limits, such as a load shedding program. The load controller 313 can include subsystems for detecting power usage by the electrical device 320 and for controlling operation of the electrical device 320 to comply with load shedding requirements. In certain exemplary embodiments, the load controller 313 can include load shedding capabilities described in U.S. Pat. No. 7,528,503, titled “Load Shedding Control for Cycled or Variable Load Appliances,” and filed Jul. 24, 2006, the entire contents of which are hereby incorporated herein by reference.

In certain exemplary embodiments, the power use sensing is accomplished through real-time current measurement. For example, one or more current transformers (not shown) may be configured to detect current draw to the electrical device 320 and the sensed current magnitudes may be provided to the load controller via an analog-to-digital converter (not shown).

The load controller 313 can include a processor, microprocessor, microcontroller, state machine, control circuit, or other appropriate technology for controlling at least one control output to the electrical device 320. In certain exemplary embodiments, the control output is a set of relays that can be operated by the load controller 313 to cycle power to the electrical device 320. In certain exemplary embodiments, the control output is a signal output that controls or commands a separate controller circuit (not shown) associated with the electrical device 320. For example, this separate control circuit may be a thermostat for an air conditioning system. The separate control circuit may also be a motor control circuit or a condenser control circuit.

The load controller 313 provides data acquisition and data logging capabilities. The load controller 313 is logically coupled to a data store 314 for storing the acquired and logged data. The data store 314 can include computer-readable media, such as RAM, ROM, hard disk, removable media, flash memory, memory stick, or other type of data storage device. The load controller 313 can log entries (e.g., hourly entries) in the data store 314 for the amount of time the electrical device 320 has been actively running, the amount of time the electrical device 320 has been controlled by the load controller 313 (e.g., as part of a load shedding program), magnitude (e.g., voltage, current level, or power level) of the electrical device 320, and power consumed by the electrical device 320. The load controller 313 can also store information related to communication mechanisms described below in the data store 314. For example, the load controller 313 can store signal strength information and communication error rate information. The load controller 313 can store any other information accessible by the load controller 313 in the data store 314 and is not limited to the aforementioned examples. The load controller 313 can also store information associated with the load control device 310 itself. For example, the load control device 310 can include a temperature sensing device logically coupled to the load controller 313. The load controller 313 can log temperature measurements received from the temperature sensing device.

The load control device 310 can also include a tamper protection mechanism (not shown). For example, the load control device 310 can include a tamper protection circuit that detects whether the end user 305 has bypassed the load control device 310, for example with an electrical conductor. The tamper protection mechanism can be logically coupled to the load controller 313 and the load controller 313 can store information related to tampering in the data store 314. The load control device 310 can also include an indicator, such as a light emitting diode (LED) that flashes when tampering is detected.

The load control device 310 can provide automatic line under voltage (LUV) protection and line under frequency (LUF) protection. These protection mechanisms can be configurable by the utility 350, for example based on the implementation.

The load control device 310 can also include one or more communication mechanisms that facilitate communication with the utility control center 380. In this exemplary embodiment, the load control device 310 includes a power line carrier (PLC) receiver 312 that receives information, such as commands for the load controller 313 or requests for information from the load controller 313, from a PLC transmitter 371 of the utility 350. The PLC receiver 312 can include a conventional PLC receiver. The PLC transmitter 371 transmits commands and requests for information by coupling a power line carrier signal onto the distribution lines 390 and modulating the phase of the carrier signal based on the information to be transmitted. The PLC receiver 312 decodes the carrier signal from the distribution lines 390 via the drop 395 and breaker panel 340 and provides the decoded signal to the load controller 313.

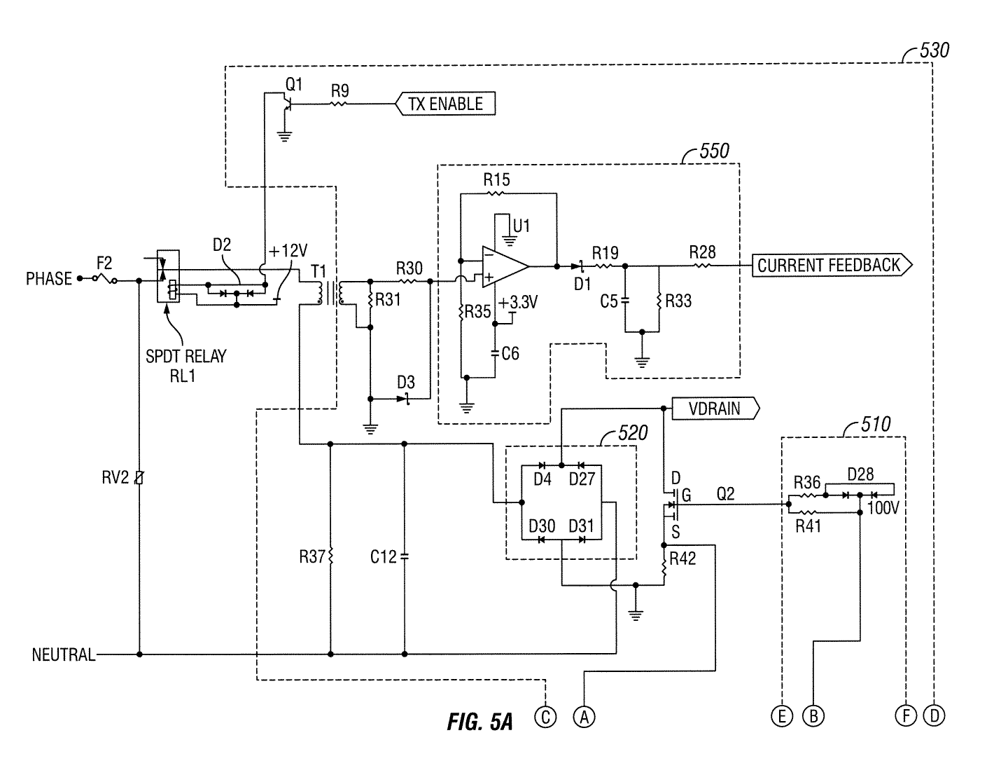

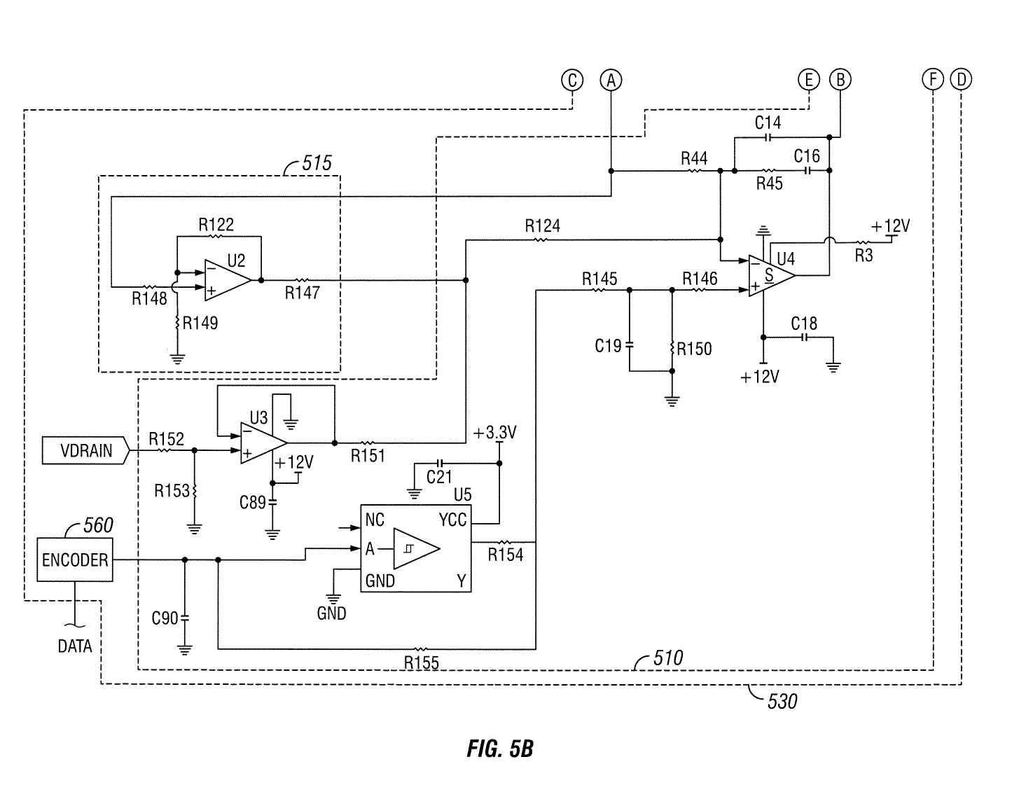

The exemplary load control device 310 also includes a PLC transmitter 311 for transmitting information to a PLC receiver 372 (which may be a conventional PLC receiver) of the utility 350. The PLC transmitter 311 can include the power line carrier stimulating device 230 illustrated in FIG. 2 and discussed above or the power line carrier stimulating device 530 illustrated in FIG. 5 and discussed below. The power line carrier stimulating device 230 or the power line carrier stimulating device 530 can be electrically coupled to the transformer 330 via the breaker panel 340 and the drop 395. That is, in an embodiment employing the power line carrier stimulating device 230, the transformer T1 of FIG. 2 represents the transformer 330. Similarly, in an embodiment employing the power line carrier stimulating device 530, the transformer T1 of FIG. 5 represents the transformer 330.

Conventional PLC transmitters are unsuitable for use with load control devices, such as the load control device 320 as they require large capacitors for coupling carrier signals onto distribution lines 390. These large capacitors would present a safety concern in a load control device installation as they operate at distribution line potential (e.g., 7.5 to 25 kV) and can store an electrical charge for a long period of time. Conventional PLC transmitters are also too large and bulky for use in a load control implementation. The exemplary PLC transmitter circuits 200 and 500 provided in FIGS. 2 and 5 make it possible to include a PLC transmitter with the load control device 310. The power line carrier stimulating devices 230 and 530 include smaller components and operates at a substantially lower voltage (e.g., 240 VAC) than that of the distribution line 390. These power line carrier stimulating devices 230 and 530 can easily be packaged in a load control device, such as load control device 310, and do not present the safety hazards that a conventional PLC transmitter would.

The PLC transmitter 311 may transmit information in response to requests for information received from the utility 350. For example, the PLC controller 313 may provide data log or other information to the PLC transmitter 311 in response to a request received via the PLC receiver 312. The PLC transmitter 312 may also provide confirmations to commands received from the utility 350. For example, after the line controller 313 receives a load shedding command and executes the command, the load controller 313 can provide a confirmation signal to the PLC transmitter 311 to transmit to the utility 350. If the load control device 310 includes a tamper protection mechanism, the load controller 313 can provide a tamper notification signal to the PLC transmitter 311 to transmit to the utility 350. These confirmations, responses to requests, and notification of tampering can be provided to the utility in real time or near real time.

As described above, phase shift keying can be accomplished by adjusting the phase of excitation pulses of the power line carrier stimulating device 230. The load controller 313 can communicate information to be transmitted to the PLC transmitter 312 and, in response, the PLC transmitter 312 can adjust the phase of the excitation pulses based on the information and a modulation scheme. The modulation scheme can include a finite number of phases that are each assigned to a pattern of binary digits. Each pattern of bits forms a symbol, such as a letter or number, that is represented by a particular phase. The PLC transmitter 312 can use the modulation scheme to encode information into the carrier signal by adjusting the phase of excitation pulses of the power line carrier stimulating device 230 or 530. The PLC receiver 372 can decode the information by detecting the phase of the carrier signal and comparing the phase to the modulation scheme.

The utility 350 can communicate with the load control device 310 using one or more communication protocols. One exemplary protocol the may be employed by the utility 350 and the load control device 310 is described in U.S. Pat. No. 7,702,424, titled, “Utility Load Control Management Communications Protocol,” filed Oct. 30, 2007, the entire contents of which are hereby incorporated herein by reference.

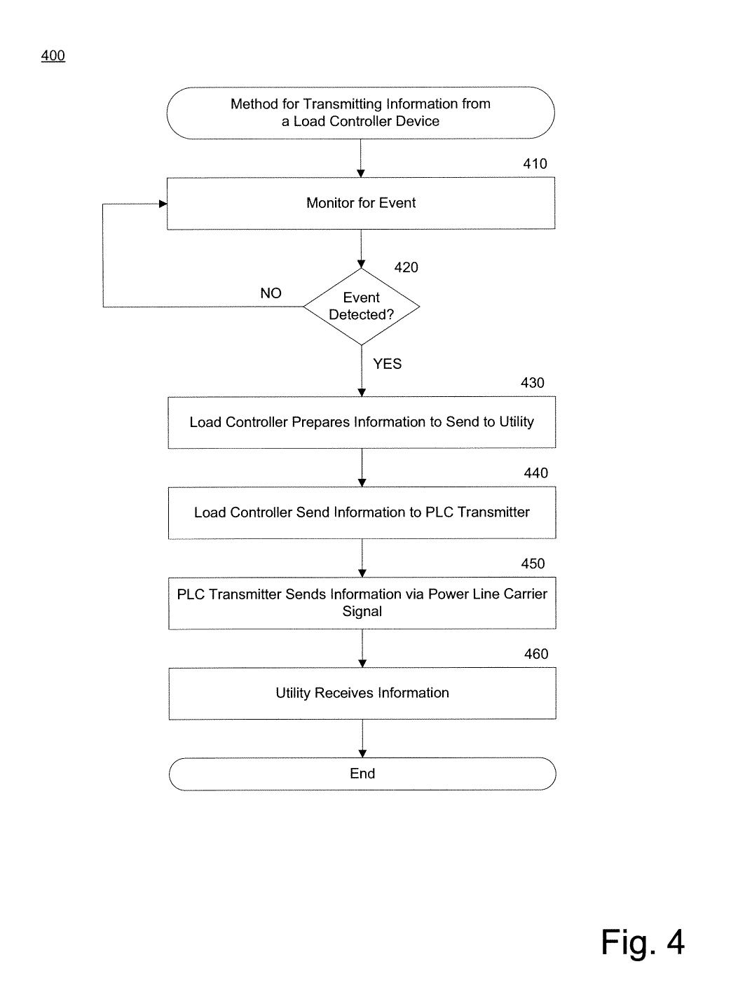

The exemplary operating environment 300 is described below with reference to the exemplary method illustrated in FIG. 4. FIG. 4 is flow chart depicting a method 400 for transmitting information from the load control device 310 to the utility 350, in accordance with certain exemplary embodiments of the present invention. Referring to FIGS. 3 and 4, in step the load controller 313 monitors for an event that triggers the load controller 313 to send information to the utility 350. The event can be a request for information received from the utility 350 (via the distribution lines 390 and the PLC receiver 312). For example, the utility 350 may request certain data logged in the data store 314. The event can be a command that triggers confirmation to the utility 350. For example, the utility 350 may issue a load shedding request to for controlling the electrical device 320. The event can be a tampering with the load control device 310. For example, the load control device 310 can include a tamper protection mechanism that provides an indication to the load controller 313 when tampering is detected. The event can also be an expiration of a time period. For example, the load controller 313 may be configured to transmit data log information based on a time period, such as once a day, once an hour, once a week, etc. The event can also be a change in certain data associated with the load control device 310 or the electrical device 320. For example, the load controller 313 may be configured to transit a message to the utility 350 anytime the load controller 313 deactivates the electrical device 320 in response to a load shedding request.

If an event is detected, in step 420, the “YES” branch is followed to step 430. Otherwise, the “NO” branch is followed to step 410 where the load controller 313 continues to monitor for an event. The load controller 313 can also continue monitoring for events after an event is received and the method proceeds to step 430.

In step 430, the load controller 313 prepares the appropriate information for sending to the utility 350. If the event included a request for information, the load controller 313 can access the data store to obtain the information. If the event is a confirmation event or a tampering event, the load controller 313 can prepare a message indicating the event.

In step 440, the load controller 313 sends the information to the PLC transmitter 311. In step 450, the PLC transmitter 311 transmits the information to the utility 350 by stimulating a power line carrier signal onto the distribution lines 390 and encoding the information into the power line carrier signal using a modulation scheme. This step 450 can includes the steps of method 100 illustrated in FIG. 1 and discussed above. In step 460, the PLC receiver 372 of the utility 350 receives the carrier signal, decodes the information using the phase of the received carrier signal and the modulation scheme, and provides the decoded information to the utility control center 380. After step 460, the method 400 ends. Of course, the load control device 310 can continue monitoring for events and transmit information in response to these events.

FIGS. 5A and 5B, collectively FIG. 5, is a schematic illustration of a circuit 500 for stimulating power line carrier injection with reactive oscillation, in accordance with certain exemplary embodiments of the present invention. The circuit 500 is an alternative embodiment to that of the circuit 200 illustrated in FIG. 2. Referring to FIG. 5, the exemplary circuit 500 includes power transformer T1 with a primary winding electrically coupled to a power line carrier stimulating device 530 and a secondary winding electrically coupled between phase and neutral distribution lines of a power distribution system via a relay RL1. The power line carrier stimulating device 530 is similar to the power line carrier stimulating device 230 illustrated in FIG. 2 and discussed above. For example, the power line carrier stimulating device 530 includes a tank circuit (including the primary winding of the power transformer T1 and a capacitor C12), a rectifier 520, a FET Q2, a current sensor 515 that detects the amount of current flowing through source S and drain D of the FET Q2 and a controller 510 that adjusts the amount of current flowing through the source S and drain D of the FET Q2 based on the amount of detected current. These components of the power line carrier stimulating device 530 can perform the same functions as the corresponding components of the power line carrier stimulating device 230.

The exemplary power line carrier stimulating device 530 also includes an encoder 560 and a switch Q1 operable to activate the power line carrier stimulating device 530 in response to receiving a transmit “TX” enable signal. The encoder 560 and switch Q1 can be logically coupled to a controller (not shown), such as a microcontroller. The encoder 560 can receive data from the microcontroller and encode the data based on a modulation scheme as discussed above. In response to receiving a TX enable signal (from the microcontroller), the switch Q1 can initiate the transmission process (illustrated in FIG. 1) causing the power line carrier stimulating device 530 to couple the encoded data onto the distribution line.

The exemplary power line carrier stimulating device 530 also includes an optional second current sensor 550. This current sensor 550 can detect the level of current flowing through the primary winding of the power transformer T1 and provide this information to another device, such as the microcontroller. This current level can be used to monitor the power level of the power line carrier signal being coupled onto the distribution line to by the power line carrier stimulating device 530.

One of ordinary skill in the art will appreciate that the present invention provides a load control device having two-way communication capabilities. The load control device can include a conventional load control receiver that receives information, such as load control commands or requests. The load control receiver can include a receiver operable to receive power line carrier signals via a power distribution line. The load control device can further include a power line carrier signal transmitter that couples a power line carrier signal onto the distribution line. The power line carrier signal transmitter can communicate information associated with the load control device and information associated with one or more electrical devices that are controlled by the load control device to a remote device. The information may be transmitted from the load control device to the remote device in response to a request received by the load control device or on a periodic basis.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A load control device, comprising:
a load controller operable to control electrical power to a device;
a power line carrier transmitter, logically coupled to the load controller, that transmits information to a remote device by coupling a first power line carrier signal to a power distribution line, the first power line carrier signal comprising the information.

2. The load control device of claim 1, further comprising a receiver logically coupled to the load controller.

3. The load control device of claim 1, wherein the receiver comprises a power line carrier receiver that receives a second power line carrier signal via the power distribution line.

4. The load control device of claim 3, wherein the receiver decodes at least one data item encoded in the second power line carrier signal and provides the decoded data item to the load controller.

5. The load control device of claim 1, wherein the load controller is further operable to collect and store data associated with the device.

6. The load control device of claim 1, wherein the power line carrier transmitter comprises:
a tank circuit that oscillates current at a frequency in response to pulses of current being sunk on the tank circuit at the frequency; and
an excitation circuit that sinks pulses of current on the tank circuit at the frequency.

7. The load control device of claim 6, wherein the load controller provides the information to the power line carrier transmitter and the power line transmitter encodes the information into the second power line carrier signal by adjusting a phase associated with the pulses of current based on the information.

8. The load control device of claim 7, wherein the load controller adjusts the phase of the pulses of current by adjusting a time period between a first pulse of current and a second pulse of current.

9. The load control device of claim 6, wherein the tank circuit comprises an inductor connected between a capacitor and a winding of a power transformer connected to the power distribution line.

10. The load control device of claim 9, wherein the capacitor comprises a first node and a second node, and wherein the pulses of current are sunk on the tank circuit by being sunk between the first node of the capacitor and the second node of the capacitor.

11. The load control device of claim 6, wherein the excitation circuit comprises a field effect transistor that comprises a source node, a drain node, and a gate node.

12. The load control device of claim 11, wherein the excitation circuit comprises a field effect transistor that comprises a source node, a drain node, and a gate node, and a control device that repeatedly applies and removes a voltage to the gate node of the field effect transistor at the frequency to open and close a channel between the source node of the field effect transistor and the drain node of the field effect transistor at the frequency.

13. The load control device of claim 12, wherein the excitation circuit further comprises:
a current sensor that measures a current flow through the field effect transistor; and
a field effect transistor control circuit that controls the current through the field effect transistor.

14. A method for transmitting information from a load control device to a remote device via a power distribution line, comprising:
coupling, by a power line carrier transmitter residing at the load control device, a power line carrier signal to the distribution line; and
adjusting a phase of the power line carrier signal based on the information for transmission.

15. The method of claim 14, further comprising receiving by the load control device a request for the information from the remote device.

16. The method of claim 14, further comprising detecting, by the load control device, tampering associated with the load control device, wherein the information is transmitted in response to the tampering and comprises information identifying the tampering.

17. The method of claim 14, further comprising receiving, by the load control device, a command identifying an action for the load control device to perform, wherein the information is transmitted in response to the command and comprises information confirming the action was performed.

18. The method of claim 14, wherein coupling the power line carrier signal to the power distribution line comprises:
providing power from the power distribution line to the power line carrier transmitter via a transformer;
exciting a tank circuit of the power line carrier transmitter to oscillate current at a frequency;
causing the oscillating current to flow through a first winding of the transformer electrically coupled to the power line carrier transmitter; and
in response to the oscillating current flowing through the first winding, coupling the oscillating current onto a second winding of the transformer connected to the power distribution line.

19. The method of claim 18, wherein exciting the tank circuit to oscillate current comprises sinking pulses of current at the frequency between a first node of a capacitor in the tank circuit and a second node of the capacitor.

20. The method of claim 19, further comprising:
measuring the amount of current flowing between the first node of the capacitor and the second node of the capacitor; and
adjusting the amount of current flowing between the first node of the capacitor and the second node of the capacitor in response to the measurement of the current that is flowing between the first node of the capacitor and the second node of the capacitor.

21. The method of claim 19, wherein adjusting the phase of the power line carrier signal comprises adjusting a time period between a first pulse of current and a second pulse of current.

22. A load control device, comprising:
a load controller operable to control power supplied to an electrical device from a power distribution system in response to a command;
a power line carrier receiver logically coupled to the load controller and operable to receive a first power line carrier signal transmitted along a power line of the power distribution system, the first power line carrier signal comprising the command; and
a power line carrier transmitter logically coupled to the load controller and operable to transmit information to the remote device by causing a second power line carrier signal to propagate along the power line to the remote device, the second power line carrier signal comprising the information.

23. The load control device of claim 22, further comprising a computer-readable media, wherein the load controller is further operable to store data associated with controlling power supplied to the electrical device with the computer-readable media.

24. The load control device of claim 22, wherein the power line carrier transmitter comprises:
a tank circuit that oscillates current at a first frequency in response to pulses of current being sunk on the tank circuit at a second frequency substantially the same as the first frequency; and
an excitation circuit that sinks pulses of current on the tank circuit at the second frequency.

25. The load control device of claim 24, wherein the load controller provides the information to the power line carrier transmitter and the power line transmitter encodes the information into the second power line carrier signal by adjusting a phase associated with the pulses of current based on the information.
